(19) United States
(12) Patent Application Publication
(10) Pub. No.: US 2022/0314965 A1
(43) Pub. Date: Oct. 6, 2022

(54) SYSTEMS AND METHODS FOR STABILIZING A VEHICLE ON TWO WHEELS

(71) Applicant: Honda Motor Co., Ltd., Tokyo (JP)

(72) Inventors: Amer ABUGHAIDA, Ann Arbor, MI (US); Yasir Khudhair AL-NADAWI, Ann Arbor, MI (US)

(21) Appl. No.: 17/219,015

(22) Filed: Mar. 31, 2021

(51) Int. Cl. B60W 30/04

(52) U.S. Cl. CPC B60W 30/04; B60W 2030/043; B60W 2030/041; B60W 2422/70; B60W 2520/16; B60W 2710/08; B60W 2710/18; B60W 2710/22; B60W 2720/16; B60W 2720/18

(57) ABSTRACT

A vehicle includes a frame having a left side and a right side, a plurality of wheels including a plurality of left wheels at the left side of the frame and a plurality of right wheels at the right side of the frame, and a vehicle stability system including an actuator device selectively actuated to balance the vehicle on either the plurality of left wheels or the plurality of right wheels while maintaining a space between the other of the plurality of left wheels or the plurality of right wheels and a ground surface.

### BACKGROUND

Known vehicles are equipped with various safety devices for protecting occupants, particularly in the event of an accident. Some known vehicles include anti-rollover systems that recognize conditions that may predict an occurrence of a vehicle rollover. However, some known anti-rollover systems may cause the vehicle to respond in an overly aggressive fashion to return all four wheels to the ground. At the other end of the spectrum, some known anti-rollover systems may identify an undesirable amount of false positives, and cause the vehicle to make unnecessary emergency measures. Moreover, at least some false positives may result in deployment of non-resettable safety restraints, requiring expensive replacement and potentially harming occupants.

### SUMMARY

Examples of this disclosure enable a vehicle to be stabilized on two wheels. In one aspect, a vehicle is provided. The vehicle may include a frame having a left side and a right side, a plurality of wheels including a plurality of left wheels at the left side of the frame and a plurality of right wheels at the right side of the frame, and a vehicle stability system including an actuator device selectively actuated to balance the vehicle on either the plurality of left wheels or the plurality of right wheels while maintaining a space between the other of the plurality of left wheels or the plurality of right wheels and a ground surface.

In another aspect, a vehicle stability system is provided for use with a vehicle including a plurality of components including a plurality of left wheels and a plurality of right wheels. The vehicle stability system includes a sensor device configured to determine a parameter associated with the vehicle, and an actuator device communicatively coupled to the sensor device. The actuator device is configured to selectively move at least one component based on the parameter to balance the vehicle on either the plurality of left wheels or the plurality of right wheels while maintaining a space between the other of the plurality of left wheels or the plurality of right wheels and a ground surface.

In yet another aspect, a method is provided for stabilizing a vehicle. The method includes determining that at least one wheel of the vehicle is spaced from a ground surface, and selectively actuating an actuator device to balance the vehicle on at least one other wheel while maintaining a space between the at least one wheel and the ground surface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The novel features believed to be characteristic of the disclosure are set forth in the appended claims. The drawings are not necessarily drawn to scale and certain drawings may be shown in exaggerated or generalized form in the interest of clarity and conciseness. The disclosure itself, however, will be best understood by reference to the following Detailed Description when read in conjunction with the accompanying drawings, wherein:

FIG. 1 is a front view of an example vehicle.

FIG. 2 is a schematic side view of the vehicle shown in FIG. 1.

FIG. 3 is a schematic top view of the vehicle shown in FIG. 1.

FIG. 4 is a schematic bottom view of the vehicle shown in FIG. 1.

FIG. 5 is an example driving system that may be used to operate a vehicle, such as the vehicle shown in FIG. 1.

FIG. 6 is an example vehicle stability system that may be used to dynamically balance a vehicle, such as the vehicle shown in FIG. 1.

FIG. 7 is a force diagram of a vehicle in an upright orientation.

FIGS. 8 and 9 are force diagrams of a vehicle operating in a “ski mode” in which at least one wheel is in contact with a ground surface while at least one other wheel is lifted or spaced from the ground surface.

FIG. 10 is a flowchart of an example method of stabilizing a vehicle 100, such as the vehicle shown in FIG. 1.

FIG. 11 is a block diagram of an example computing system that may be used to perform one or more computing operations, such as those in FIG. 10.

Like parts are marked throughout the drawings, as well as throughout the Detailed Disclosure, with the same numerals. Although specific features may be shown in some of the drawings and not in others, this is for convenience only. In accordance with the examples described herein, any feature of a drawing may be referenced and/or claimed in combination with any feature of any other drawing.

### DETAILED DESCRIPTION

The present disclosure relates to vehicles and, more particularly, to methods and systems for stabilizing a vehicle on two wheels. Examples described herein include a sensor device configured to determine a parameter associated with a vehicle, and an actuator device configured to selectively move at least one component of the vehicle based on the parameter in order to balance the vehicle on at least one wheel while maintaining a space between at least one other wheel and a ground surface. Examples described herein enable the vehicle to be stabilized while at least one wheel is spaced from the ground surface (e.g., during a rollover event). In at least this manner, the examples described herein promote safety and efficiency beyond those provided by conventional stability systems. Other benefits and advantages will become clear from the disclosure provided herein, and those advantages provided are for illustration.

Examples described herein are configured to operate using one or more computer systems that are communicatively coupled to one or more sensors and operably connected to one or more actuator devices. For example, the technical effect of the systems and processes described herein may be achieved by performing at least one of the following operations: (i) determining that at least one wheel of the vehicle is spaced from a ground surface; and (ii) selectively actuating an actuator device to balance the vehicle on at least one other wheel while maintaining a space between the at least one wheel and the ground surface. The systems and processes described herein may be implemented using computer programming or engineering techniques including computer software, firmware, hardware or a combination or subset thereof. While the examples described herein are described with respect to the operation of passenger vehicles, one of ordinary skill in the art would understand and appreciate that the subject matter described herein may be used for various other uses and/or applications.

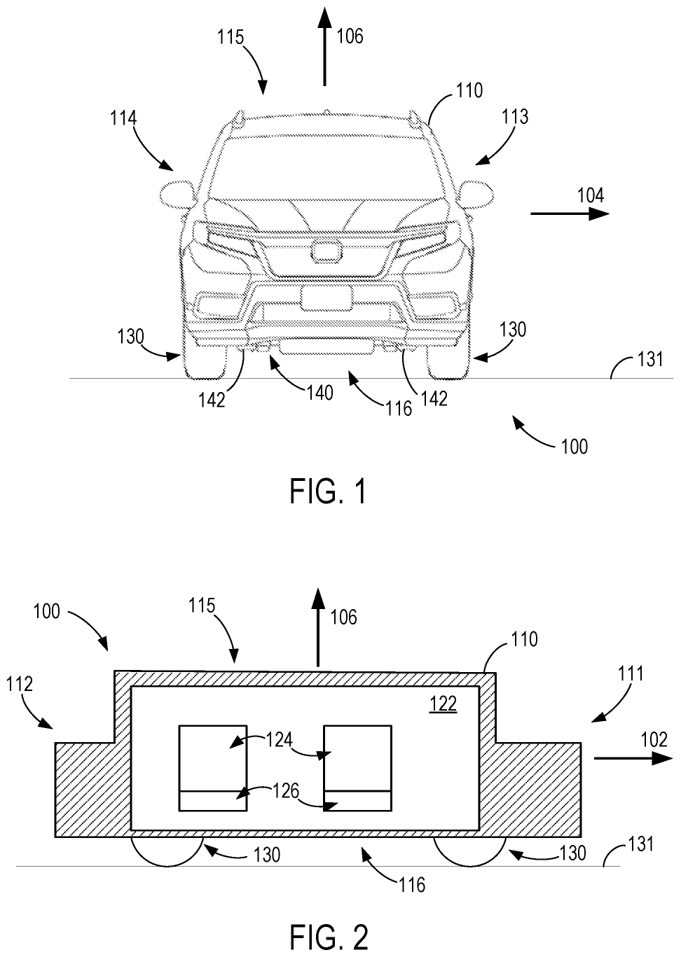

FIGS. 1-4 shows an example vehicle 100 in a three-dimensional coordinate system including a longitudinal axis 102 (e.g., an X-axis) (shown in FIGS. 2-4), a lateral axis 104 (shown in FIGS. 1, 3 and 4) (e.g., a Y-axis), and a vertical axis 106 (shown in FIGS. 1 and 2) (e.g., a Z-axis). The vehicle 100 may include a frame 110 having a front 111 (shown in FIGS. 2-4) toward a positive X-direction, a rear 112 (shown in FIGS. 2-4) toward a negative X-direction, a left side 113 (shown in FIGS. 1, 3, and 4) toward a positive Y-direction, a right side 114 (shown in FIGS. 1, 3, and 4) toward a negative Y-direction, a top 115 (shown in FIGS. 1 and 2) toward a positive Z-direction, and a bottom 116 (shown in FIGS. 1 and 2) toward a negative Z-direction.

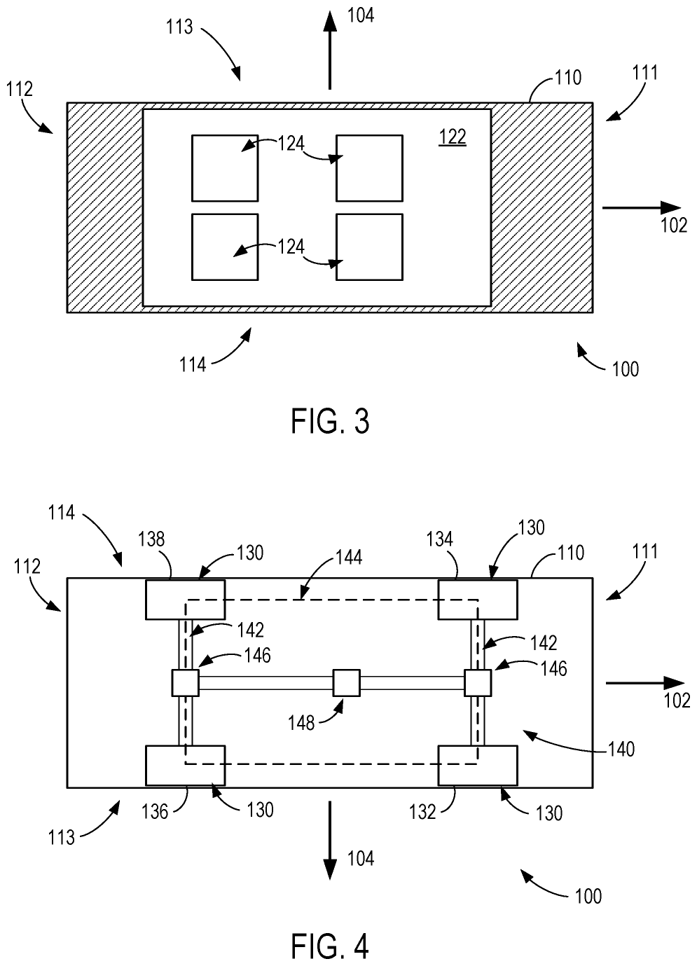

The vehicle 100 may be configured to accommodate one or more occupants, including a driver and/or operator. For example, as shown in FIGS. 2 and 3, the frame 110 may define an interior space or cabin 122 in which one or more occupants may be seated in one or more seats 124. In some examples, each seat 124 is coupled to a respective mount 126 (shown in FIG. 2) that enables the seat 124 to be selectively moved relative to the frame 110 within the cabin 122. For example, the mounts 126 may be used to move the seats 124 along or parallel to the longitudinal axis 102, lateral axis 104, and/or vertical axis 106. While the vehicle 100 is described and shown to include four seats 124, one of ordinary skill in the art would understand and appreciate that the vehicle 100 described herein may include any quantity of seats 124 in various arrangements.

The frame 110 may be coupled to a plurality of wheels 130 that selectively engage a ground surface 131 (shown in FIGS. 1 and 2) (e.g., at a contact patch) to support the vehicle 100. The wheels 130 include at least one wheel 130 on the left side 113 and at least one wheel 130 on the right side 114. For example, as shown in FIG. 4, the wheels 130 may include a front left wheel 132, a front right wheel 134, a rear left wheel 136, and a rear right wheel 138. While the vehicle 100 is described and shown to include four wheels 130, one of ordinary skill in the art would understand and appreciate that the vehicle 100 described herein may include any quantity of wheels 130 in various arrangements.

As shown in FIGS. 1 and 4, the wheels 130 may be coupled to the frame 110 using a suspension system 140 that allows relative movement therebetween. The wheels 130 may move along or parallel to the vertical axis 106, for example, to selectively engage the ground surface 131. In some examples, the wheels 130 may selectively engage the ground surface while the vehicle 100 is in motion to insulate the occupants from irregularities in the ground surface 131.

In some examples, the suspension system 140 may include one or more axle assemblies 142 configured to move the wheels 130 for modifying a wheelbase 144 (shown in FIG. 4) of the vehicle 100. For example, an axle assembly 142 may be used to move one or more wheels 130 along or parallel to the longitudinal axis 102, lateral axis 104, and/or vertical axis 106 to modify a length, width, and/or height of the wheelbase 144, respectively. Additionally or alternatively, the axle assembles 142 may be used to control a camber angle, a caster angle, a toe angle, a thrust angle, and/or a slip angle associated with one or more wheels 130. In some examples, the axle assemblies 142 may include telescoping cylinders, control links, and/or one or more articulated joints. As used herein, the term “wheelbase” may refer to a distance, area, and/or volume defined between a plurality of wheels 130.

As shown in FIG. 4, the suspension system 140 may include one or more locking differential assemblies 146 configured to control a rotation of the wheels 130. For example, a locking differential assembly 146 may be coupled to an axle assembly 142 to coordinate or synchronize rotation of all of the wheels 130 coupled to the axle assembly 142 (e.g., front left wheel 132 and front right wheel 134 or rear left wheel 136 and rear right wheel 138). In some examples, the suspension system 140 includes a transfer case 148 configured to coordinate or synchronize rotation of one or more wheels 130 coupled to one axle assembly 142 (e.g., front left wheel 132 and/or front right wheel 134) with rotation of one or more wheels 130 coupled to another axle assembly 142 (e.g., rear left wheel 136 and/or rear right wheel 138). The transfer case 148 may be used, for example, to transfer power between the axle assemblies 142 for use in rotating the wheels 130 in unison (e.g., at the same rate or speed). In some examples, the transfer case 148 may be used to selectively operate the vehicle 100 in a two-wheel drive (2WD) mode or a four-wheel drive (4WD) mode. In an alternative embodiment, one or more electric motors may be configured to rotate at least one of the wheels 130 to propel the vehicle 100. For example, one electric motor may be operably coupled to axle assembly 142 and configured to rotate front left wheel 132 and front right wheel 134. Alternatively, a first electric motor may be configured to rotate front left wheel 132 and a second electric motor may be configured to rotate front right wheel 134. Moreover, one or more electric motors may be configured to also rotate rear left wheel 136 and rear right wheel 138.

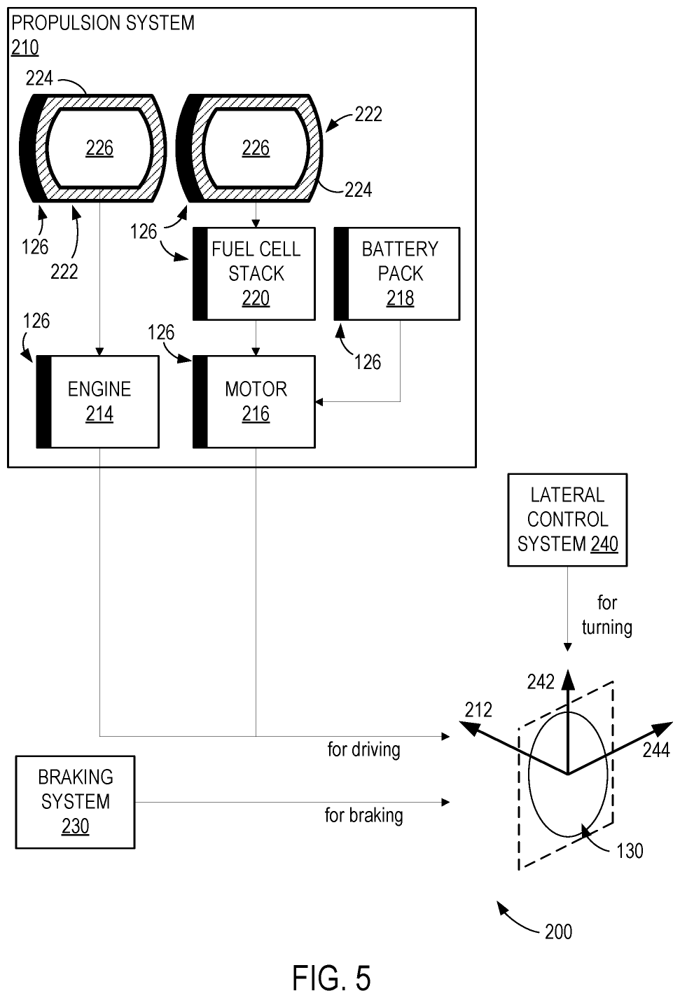

FIG. 5 shows an example driving system 200 that may be used to operate the vehicle 100. The driving system 200 may be used, for example, to perform one or more driving functions. In some examples, the driving system 200 includes a propulsion system 210 operably connected to the wheels 130 for use in moving or propelling the vehicle 100. The propulsion system 210 may be used, for example, to drive or rotate one or more wheels 130 about a rotational axis 212 (e.g., via the axle assemblies 142 and/or locking differential assemblies 146).

In some examples, the propulsion system 210 may include an internal combustion engine 214 and/or an electric motor 216 configured to generate mechanical power for use in driving the wheels 130. To generate mechanical power, the internal combustion engine 214 may burn fuel, and/or the electric motor 216 may draw electricity from a battery pack 218 and/or a fuel cell stack 220. In some examples, fuel may be channeled to the internal combustion engine 214 and/or fuel cell stack 220 from one or more fuel tanks 222. Each fuel tank 222 may include one or more walls 224 that define a cavity 226 in which fuel may be stored. In some examples, the walls 224 that may be moved to selectively adjust a size, shape, and/or position of the fuel tank 222. Example fuels that may be stored in the fuel tanks 222 include, without limitation, gasoline, diesel, hydrogen, natural gas, biodiesel, ethanol, and propane.

In some examples, the locking differential assemblies 146 and/or transfer case 148 are used to drive the wheels 130 about their respective rotational axes 212 at the same rate or speed, regardless of traction or load. For example, the locking differential assemblies 146 may enable the axle assembles 142 to simultaneously provide torque to all of the wheels 130 coupled thereto. Additionally or alternatively, the locking differential assemblies 146 may enable the axle assembles 142 to restrict or prevent one wheel 130 coupled thereto from rotating at a speed that is different from that of another wheel 130 coupled thereto. In some examples, a braking system 230 may be used to restrict rotation of one or more wheels 130 about the rotational axis 212. In some examples, the braking system 230 may be configured to coordinate or synchronize a rotation of the wheels 130. For example, the braking system 230 may be used to independently control a brake for each wheel 130 (e.g., apply “differential braking”) to ensure that the wheels 130 rotate at the same rate or speed as each other.

In some examples, components of the propulsion system 210 (e.g., internal combustion engine 214, electric motor 216, battery pack 218, fuel cell stack 220, fuel tank 222) are coupled to one or more mounts 126 configured to support the components. The mounts 126 may be used, for example, to selectively move the internal combustion engine 214, electric motor 216, battery pack 218, fuel cell stack 220, and/or fuel tank 222 along or parallel to the longitudinal axis 102, lateral axis 104, and/or vertical axis 106 of the vehicle 100.

In some examples, the driving system 200 includes a steering or lateral control system 240 operably connected to the wheels 130 for use in directing or steering the vehicle 100. Generally, the vehicle 100 is configured to move straight forwards or backwards (e.g., along or parallel to the longitudinal axis 102) when the wheels 130 are in a straight orientation (e.g., when the rotational axis 212 of each wheel 130 extends along or parallel to the lateral axis 104 of the vehicle 100). To steer the vehicle 100 towards the left or right, the lateral control system 240 may be used to move at least one wheel 130 away from the straight orientation. For example, the at least one wheel 130 may be turned or rotated about a yaw axis 242 such that the rotational axis 212 of the at least one wheel 130 is askew to the lateral axis 104 and/or a longitudinal axis 244 of the at least one wheel 130 is askew to the longitudinal axis 102 of the vehicle 100. In some examples, the lateral control system 240 may include front steering, rear steering, torque vectoring, selective braking, and the like.

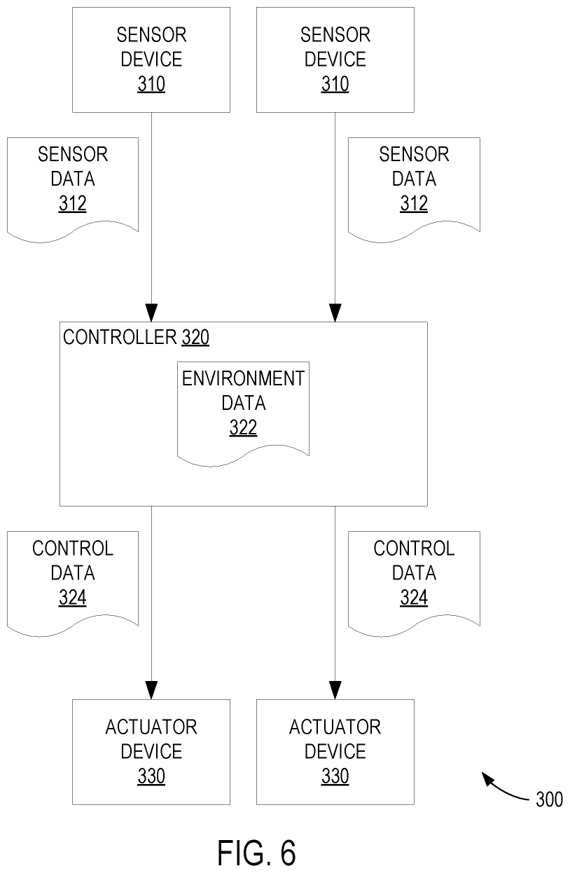

FIG. 6 shows an example vehicle stability system 300 that may be used to dynamically balance the vehicle 100. In some examples, the vehicle stability system 300 enables the vehicle 100 to be stabilized on two wheels 130 (e.g., front left wheel 132 and rear left wheel 136 or front right wheel 134 and rear right wheel 138). The vehicle stability system 300 may include a plurality of sensor devices 310 configured to detect one or more physical properties or stimuli at and/or proximate to the frame 110, seats 124, mounts 126, wheels 130, ground surface 131, axle assemblies 142, locking differential assemblies 146, transfer case 148, internal combustion engine 214, electric motor 216, battery pack 218, fuel cell stack 220, fuel tanks 222, braking system 230, and/or lateral control system 240. Example sensor devices 310 include, without limitation, an accelerometer, an inertial measurement unit (IMU), a gyroscope, a level sensor, a magnetometer, a piezoelectric sensor, a load cell, a microphone, a camera, a photoelectric sensor, an infrared sensor, a microwave sensor, an ultrasonic sensor, a motion detector, a rotary encoder, a receiver, a transceiver, and any other device configured to detect a physical property or stimulus in the vehicle 100 and/or its environment. While the vehicle 100 is described and shown to include two sensor devices 310, one of ordinary skill in the art would understand and appreciate that the vehicle 100 described herein may include any quantity of sensor devices 310 that enables the vehicle stability system 300 to function as described herein.

The sensor devices 310 may be used to determine one or more parameters and generate one or more signals or sensor data 312 based on the determined parameters. Example parameters may include, without limitation, a position, an orientation, a velocity, an acceleration, a force, and/or a moment associated with the vehicle 100 and/or its components. For example, a vehicle attitude sensor (e.g., accelerometer, IMU) may be used to determine a position and/or an orientation of the vehicle 100, a wheel load sensor (e.g., piezoelectric sensor) may be used to determine a force and/or pressure applied to one or more wheels 130, and/or a proximity sensor (e.g., infrared sensor, ultrasonic sensor) may be used to determine a presence of the ground surface 131 in an area proximate to one or more wheels 130.

In some examples, the sensor devices 310 transmit or provide sensor data 312 to an electronic control unit (ECU) or controller 320 for processing. The sensor data 312 may be processed, for example, to convert the sensor data 312 into one or more other forms (e.g., an analog signal to a digital form), to remove at least some undesired portions (“noise”), and/or to determine one or more parameters associated with the vehicle 100 and/or its environment. In some examples, the controller 320 uses the sensor data 312 to generate environment data 322 that enables a computing device (e.g., controller 320) to recognize, identify, map, and/or understand the environment and/or one or more objects in the environment. Environment data 322 may be generated, for example, using a haversine formula, Kalman filter, particle filter, simultaneous localization and mapping (“SLAM”) algorithm, and the like.

In some examples, the controller 320 may use the sensor data 312 and/or environment data 322 to determine or identify an attitude and/or a trajectory of the vehicle 100. For example, the controller 320 may identify a position, orientation, velocity, and/or acceleration of the vehicle 100 relative to the ground surface 131 and/or one or more objects in the environment. In some examples, the attitude and/or trajectory may be monitored or tracked over time (e.g., with respect to an initial attitude, a zero calibration, and/or a local coordinate system) to determine whether one or more wheels 130 are spaced from the ground surface 131.

The controller 320 may also use the sensor data 312 and/or environment data 322 to generate control data 324. Control data 324 includes any information that enables a computing device (e.g., controller 320) to control or operate some aspect of the vehicle 100. In some examples, the controller 320 transmits or provides control data 324 to one or more actuator devices 330 for use in maneuvering the vehicle 100. Control data 324 may be transmitted or provided, for example, to the propulsion system 210, braking system 230, and/or lateral control system 240 for use in propelling, braking, and/or steering of the vehicle 100, respectively. In some examples, control data 324 may be transmitted or provided to the suspension system 140 for use in adjusting a wheelbase 144. Additionally or alternatively, control data 324 may be transmitted or provided to the suspension system 140, propulsion system 210, braking system 230, and/or lateral control system 240 for use in adjusting a weight distribution of the vehicle 100. In some examples, control data 324 may allow or enable an occupant of the vehicle 100 (e.g., operator) to control or operate the vehicle 100. While the vehicle 100 is described and shown to include two actuator devices 330, one of ordinary skill in the art would understand and appreciate that the vehicle 100 described herein may include any quantity of actuator devices 330 that enables the vehicle stability system 300 to function as described herein.

In some examples, the controller 320 may communicate with one or more computing devices (e.g., sensor devices 310, actuator devices 330) using one or more wireless communication protocols. Example wireless communication protocols include, without limitation, wireless protocols, a BLUETOOTH® brand communication protocol, a ZIGBEE® brand communication protocol, a Z-WAVE™ brand communication protocol, a WI-FI® brand communication protocol, a near field communication (NFC) communication protocol, a radio frequency (RF) communication protocol, an infrared (IR) communication protocol, an ultrasound (US) communication protocol, and/or a cellular data communication protocol. (BLUETOOTH® is a registered trademark of Bluetooth Special Interest Group, ZIGBEE® is a registered trademark of ZigBee Alliance Corporation, Z-WAVE™ is a trademark of Sigma Designs, Inc., and WI-FI® is a registered trademark of the Wi-Fi Alliance.).

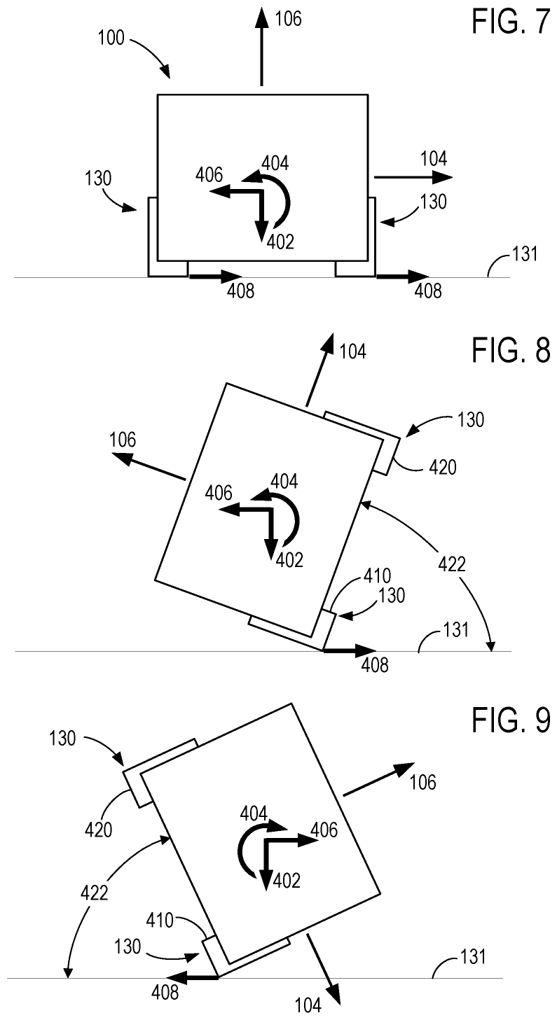

FIG. 7 shows the vehicle 100 in an upright orientation in which all of the wheels 130 are engaging the ground surface 131. As shown in FIG. 7, a gravitational force 402 urges the vehicle 100 toward the ground surface 131 (e.g., in a negative Z-direction) at a center of gravity of the vehicle 100. In some examples, a roll moment 404 may urge the vehicle 100 to roll or rotate about a roll axis extending along or parallel to the longitudinal axis 102 of the vehicle 100 (and perpendicular to the plane of FIG. 7). The roll moment 404 may be created, for example, during one or more turning maneuvers in which an inertial force 406 (e.g., centrifugal force) urges the vehicle 100 away from a direction of a turn at the center of gravity and a cornering force 408 (e.g., frictional force) urges the vehicle 100 toward the direction of the turn at the ground surface 131 (e.g., at the contact patch). Additionally or alternatively, the roll moment 404 may be created upon impact with one or more other objects (e.g., another vehicle, a curb, a guard rail, a median divider, a wall).

FIGS. 8 and 9 show the vehicle 100 operating in a “ski mode” in which at least one wheel 130 (e.g., a “down” wheel 410) is in contact with the ground surface 131 while at least one other wheel 130 (e.g., an “up” wheel 420) is lifted or spaced from the ground surface 131. As shown in FIG. 8, the vehicle 100 may be rotated in one direction about the roll axis such that the down wheel 410 is on the right side 114 of the vehicle 100 and the up wheel 420 is on the left side 113 of the vehicle 100. Alternatively, the vehicle 100 may be rotated in the opposite direction about the roll axis such that the down wheel 410 is on the left side 113 of the vehicle 100 and the up wheel 420 is on the right side 114 of the vehicle 100. As shown in FIGS. 8 and 9, the down wheel 410 may be controlled and/or used with the shoulder or sidewall engaging the ground surface 131.

To stabilize the vehicle 100 on at least one down wheel 410, the controller 320 may generate control data 324 that facilitates decreasing an absolute value of the roll moment 404. In some examples, the controller 320 may generate control data 324 to balance the vehicle 100 by dynamically adjust a steering angle (e.g., defined between the longitudinal axis 244 of the wheel 130 and the longitudinal axis 102 of the vehicle 100) and/or a longitudinal speed of the vehicle 100. For example, to increase an angle 422 defined between the vehicle 100 and the ground surface 131 (e.g., to elevate the up wheels 420), the actuator devices 330 may use the lateral control system 240 (e.g., steering wheel) to rotate the wheels 130 about the yaw axis 242 toward the side of the up wheel 420. On the other hand, the actuator devices 330 may use the lateral control system 240 to rotate the wheels 130 about the yaw axis toward the side of the down wheel 410 to decrease the angle 422 defined between the vehicle 100 and the ground surface 131 (e.g., to lower the up wheels 420). Additionally or alternatively, the actuator devices 330 may use the propulsion system 210 (e.g., a gas pedal) and/or braking system 230 (e.g., a brake pedal) to control the inertial force 406 and/or cornering force 408 by increasing or decreasing the longitudinal speed of the vehicle 100, respectively. Stabilizing the vehicle 100 on at least one down wheel 410 while at least one other wheel 130 is up, in some circumstances, may be safer than controlling vehicle components to prevent any of wheels 130 from ever leaving the ground surface 131. For example, the vehicle 100 may be stabilized on two wheels 130 to avoid an obstacle. Furthermore, stabilizing the vehicle 100 on at least one down wheel 410 while at least one other wheel 130 is up may also be safer than controlling vehicle components to immediately return all wheels 130 to the ground surface 131. For example, the vehicle 100 may be stabilized on two wheels 130 to reduce the impact of bringing the vehicle 100 back to the upright orientation by performing a controlled return of the up wheels 420 to the ground surface 131 (e.g., at a time, location, and/or rate determined to be safe).

In some examples, the controller 320 may generate control data 324 to balance the vehicle 100 by dynamically adjusting the roll axis and/or center of gravity of the vehicle 100. To adjust the roll axis, the actuator devices 330 may use the suspension system 140 (e.g., axle assemblies 142) to change a shape, size, and/or configuration of the suspension system 140 by moving one or more wheels 130 along or parallel to the longitudinal axis 102, lateral axis 104, and/or vertical axis 106 and/or orienting the wheels 130 to control a camber angle, a caster angle, a toe angle, a thrust angle, and/or a slip angle thereof. In some examples, changing the shape, size, and/or configuration of the suspension system 140 may also affect a weight distribution of the vehicle 100, thereby changing the center of gravity. In some examples, the controller 320 may generate control data 324 to balance the vehicle 100 by dynamically adjusting tire pressure. Additionally or alternatively, the actuator devices 330 may be actuated to adjust the weight distribution of the vehicle 100 by using one or more mounts 126 to move a seat 124, an internal combustion engine 214, an electric motor 216, a battery pack 218, a fuel cell stack 220, and/or a fuel tank 222. For example, disturbances of weight shuffling may be limited by utilizing a fuel cell stack 220 over the fuel tank 222. In some examples, the actuator devices 330 may use the propulsion system 210 to adjust the weight distribution of the vehicle 100 by moving at least one wall 224 of the fuel tank 222 to adjust a size, shape, and/or position of the fuel tank 222. The at least one wall 224 may be moved, for example, to redistribute or transfer fuel to a different space within the fuel tank 222 and/or to another fuel tank 222. In some examples, the walls 224 may be moved to confine the fuel to a smaller space within the fuel tank 222 (e.g., to reduce fuel sloshing).

In some examples, the controller 320 may be configured to proactively switch between generating control data 324 to operate the vehicle 100 in the ski mode and generating control data 324 to operate the vehicle 100 in a “normal mode” in which the vehicle 100 is stabilized on four wheels 130. For example, the controller 320 may generate control data 324 to operate the vehicle 100 in the ski mode when one or more wheels 130 are projected to be (but are not yet) spaced from the ground surface 131. Additionally or alternatively, the controller 320 may generate control data 324 to operate the vehicle 100 in the ski mode to traverse narrower roadways and/or to navigate around one or more obstacles in a projected path. In some examples, the controller 320 may communicate with one or more sensor devices 310 (e.g., a global positioning system (GPS) device, a local positioning system (LPS) device, a vision positioning system (VPS) device, a light imaging detection and ranging (LIDAR) device, a radio detection and ranging (RADAR) device, a sound navigation and ranging (SONAR) device) to detect and/or identify one or more roadways and/or obstacles. To proactively create a roll moment 404, the actuator devices 330 may use the propulsion system 210, braking system 230, and/or lateral control system 240 to perform one or more turning maneuvers. In some examples, the actuator devices 330 may use one or more other systems to lift or elevate one side of the vehicle 100. For example, the suspension system 140 (e.g., axle assemblies 142) may be used to vertically move the wheels 130 on one side of the vehicle 100 along or parallel to the vertical axis 106.

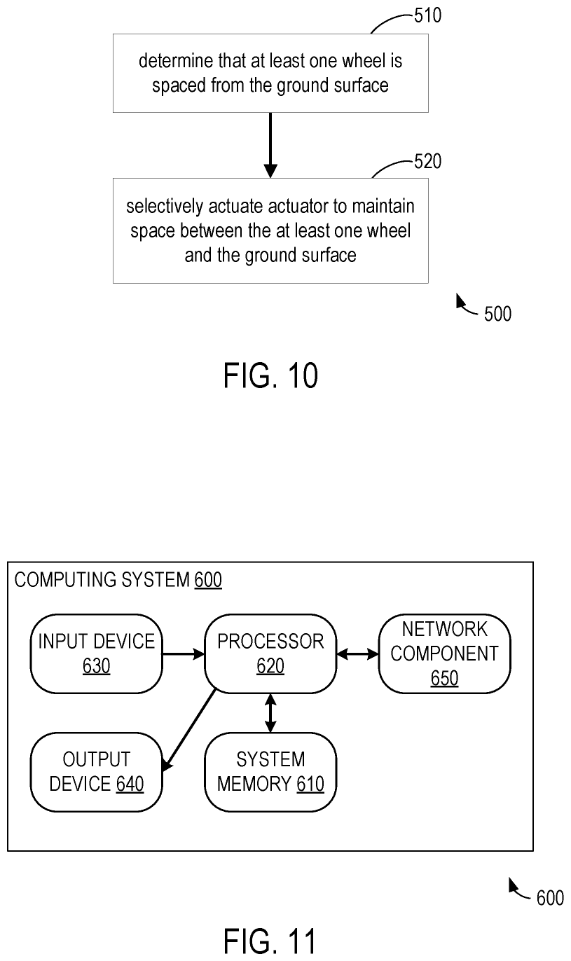

FIG. 10 shows an example method 500 of stabilizing a vehicle 100. The vehicle 100 may be stabilized, for example, using a vehicle stability system 300. The method 500 will be described with reference to the elements of FIGS. 1-9, though it is to be appreciated that the method 500 may be used with other systems and/or components.

In some examples, it is determined at operation 510 that at least one wheel 130 of the vehicle 100 is spaced from (or likely to be spaced from) the ground surface 131. The determination may be made based on sensor data 312 and/or environment data 322. For example, at least one wheel 130 on a first side of the vehicle 100 may be determined to be spaced from the ground surface 131 when sensor data 312 and/or environment data 322 indicate (i) a relatively high lateral acceleration in a direction towards an opposite second side of the vehicle 100, (ii) a relatively low wheel load on the first side of the vehicle 100, (iii) a relatively high wheel load on the second side of the vehicle 100, (iv) a relatively large distance between the ground surface 131 and the at least one wheel 130 on the first side of the vehicle 100, (v) a relatively small distance between the ground surface 131 and at least one wheel 130 on the second side of the vehicle 100, (vi) an absence of the ground surface 131 from an area proximate to the at least one wheel 130 on the first side of the vehicle 100, and/or (vii) a presence of the ground surface 131 in an area proximate to the at least one wheel 130 on the second side of the vehicle 100.

Upon determining that the at least one wheel 130 on the first side of the vehicle 100 (e.g., up wheels 420) is spaced from the ground surface 131, the vehicle 100 may be stabilized on the at least one wheel 130 on the second side of the vehicle 100 (e.g., down wheels 410) by selectively actuating one or more actuator devices 330 at operation 520. The actuator device 330 may be selectively actuated, for example, to maintain a space or distance between the up wheels 420 and the ground surface 131 and/or decrease an absolute value of the roll moment 404.

In some examples, the vehicle 100 may be balanced on the down wheels 410 while the up wheels 420 are lifted or spaced from the ground surface 131 by dynamically adjusting a steering angle and/or longitudinal speed of the vehicle 100 to generate inertial force 406 and/or cornering force 408 that counteract the gravitational force 402 on the vehicle 100. For example, the lateral control system 240 may be used to position the center of gravity over the down wheels 410 (e.g., at the contact patch), and/or the propulsion system 210 and/or braking system 230 may be used to adjust the longitudinal speed of the vehicle 100. Additionally or alternatively, one or more actuator devices 330 may be selectively actuated to dynamically adjust a roll axis and/or a center of gravity of the vehicle 100 by using the suspension system 140 to position and/or orient one or more wheels 130 and/or axle assemblies 142. In some examples, the roll axis and/or center of gravity may be dynamically adjusted by using one or more mounts 126 to selectively position and/or orient the seats 124, internal combustion engine 214, electric motor 216, battery pack 218, fuel cell stack 220, and/or fuel tank 222. In some examples, the actuator devices 330 may be selectively actuated to control fuel sloshing by moving at least one wall 224 of a fuel tank 222.

In some examples, the vehicle 100 may operate in an automated mode in which the controller 320 generates control data 324 to control one or more dynamic driving tasks (e.g., steering, accelerating, braking) in hard real-time or soft real-time for automatically or autonomously controlling the vehicle 100. The vehicle stability system 300 described herein may be used with one or more other automatic vehicle control systems and/or autonomous driving applications, including those associated with stability control, traction control, tire pressure monitoring, anti-lock brakes, electronic brake distribution, brake assist, lane keeping, dynamic steering response, adaptive cruise control, collision mitigation, lane keeping, blind spot monitoring, sign recognition, and/or rollover avoidance.

FIG. 11 shows an example computing system 600 configured to perform one or more computing operations. While some examples of the disclosure are illustrated and described herein with reference to the computing system 600 being a controller 320 (shown in FIG. 6), aspects of the disclosure are operable with any computing system (e.g., sensor devices 310, actuator devices 330) that executes instructions to implement the operations and functionality associated with the computing system 600. The computing system 600 shows only one example of a computing environment for performing one or more computing operations and is not intended to suggest any limitation as to the scope of use or functionality of the disclosure.

In some examples, the computing system 600 includes a system memory 610 (e.g., computer storage media) and a processor 620 coupled to the system memory 610. The processor 620 may process signals and perform general computing and arithmetic functions. Signals processed by the processor 620 may include digital signals, data signals, computer instructions, processor instructions, messages, a bit, a bit stream, or other means that can be received, transmitted and/or detected. Generally, the processor 620 may include various processors including multiple single and multicore processors and co-processors and other multiple single and multicore processor and co-processor architectures. For example, the processor 620 may include one or more processing units (e.g., in a multi-core configuration). Although the processor 620 is shown separate from the system memory 610, examples of the disclosure contemplate that the system memory 610 may be onboard the processor 620, such as in some embedded systems.

The processor 620 is programmed or configured to execute computer-executable instructions stored in the system memory 610 to stabilize a vehicle 100 on two down wheels 410 and/or implement other aspects of the disclosure using one or more controllers 320. The system memory 610 includes one or more computer-readable media that allow information, such as the computer-executable instructions and other data, to be stored and/or retrieved by the processor 620. In some examples, the processor 620 executes the computer-executable instructions to determine a parameter associated with the vehicle 100 and selectively actuate one or more actuators (e.g., actuator device 330) based on the parameter to maintain a space between at least one up wheel 420 and a ground surface 131.

By way of example, and not limitation, computer-readable media may include computer storage media and communication media. Computer storage media are tangible and mutually exclusive to communication media. For example, the system memory 610 may include computer storage media in the form of volatile and/or nonvolatile memory, such as read-only memory (ROM), programmable ROM (PROM), erasable PROM (EPROM), electrically erasable PROM (EEPROM), solid-state drives, magnetic tape, a floppy disk, a hard disk, a compact disc (CD), a digital versatile disc (DVD), a memory card, a flash drive, random-access memory (RAM), static RAM (SRAM), dynamic RAM (DRAM), synchronous DRAM (SDRAM), double data rate SDRAM (DDR SDRAM), and/or any other medium that may be used to store desired information that may be accessed by the processor 620. Computer storage media are implemented in hardware and exclude carrier waves and propagated signals. That is, computer storage media for purposes of this disclosure are not signals per se.

A user (e.g., operator) may enter commands and other input into the computing system 600 through one or more input devices 630 (e.g., sensor device 310) coupled to the processor 620. The input devices 630 are configured to receive information. Example input devices 630 include, without limitation, a pointing device (e.g., mouse, trackball, touch pad, joystick), a keyboard, a game pad, a controller, a microphone, a camera, a gyroscope, an accelerometer, a position detector, and an electronic digitizer (e.g., on a touchscreen). Information, such as text, images, video, audio, and the like, may be presented to a user via one or more output devices 640 (e.g., actuator device 330) coupled to the processor 620. The output devices 640 are configured to convey information. Example output devices 640 include, without limitation, a monitor, a projector, a printer, a speaker, a vibrating component. In some examples, an output device 640 is integrated with an input device 630 (e.g., a capacitive touch-screen panel, a controller including a vibrating component).

One or more network components 650 may be used to operate the computing system 600 in a networked environment using one or more logical connections. Logical connections include, for example, local area networks, wide area networks, and the Internet. The network components 650 allow the processor 620, for example, to convey information to and/or receive information from one or more remote devices, such as another computing system or one or more remote computer storage media. Network components 650 may include a network adapter, such as a wired or wireless network adapter or a wireless data transceiver.

The following includes definitions of selected terms employed herein. The definitions include various examples and/or forms of components that fall within the scope of a term and that can be used for implementation. The examples are not intended to be limiting.

A “bus”, as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk”, as used herein can be or include, for example, magnetic tape, a floppy disk, a hard disk, a compact disc (CD), a digital versatile disc (DVD), a memory card, and/or a flash drive. The disk can store an operating system that controls or allocates resources of a computing device.

An “operable connection”, or a connection by which entities are “operably connected”, is one in which signals, physical communications, and/or logical communications can be sent and/or received. An operable connection can include a wireless interface, a physical interface, a data interface and/or an electrical interface.

A “unit”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another unit, method, and/or system. A unit may also include logic, a software controlled microprocessor, a discrete logic circuit, an analog circuit, a digital circuit, a programmed logic device, a memory device containing executing instructions, logic gates, a combination of gates, and/or other circuit components. Multiple units may be combined into one unit and single units may be distributed among multiple units.

A “value” and “level”, as used herein can include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage. In other cases, the value or level of X could be a value in a range. In still other cases, the value or level of X may not be a numerical value, but could be associated with a given discrete state, such as “not X”, “slightly X”, “X”, “very X” and “extremely X.”

This written description uses examples to disclose aspects of the disclosure and also to enable a person skilled in the art to practice the aspects, including making or using the above-described systems and executing or performing the above-described methods. The example vehicles described herein include or are coupled to a vehicle stability system that tracks or monitors one or more parameters in real time to facilitate balancing the vehicle on two down wheels in order to maintain or increase a space between at least one up wheel and the ground surface. In this manner, the example vehicle stability systems may be used to increase a stability of the vehicle and/or reduce a likelihood of rollover.

Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

It should be apparent from the foregoing description that various examples may be implemented in hardware. Furthermore, various examples may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

When introducing elements, the articles “a”, “an”, “the” and “said” are intended to mean that there are one or more of the elements. References to an “embodiment” or an “example” of the present disclosure are not intended to be interpreted as excluding the existence of additional embodiments or examples that also incorporate the recited features. The terms “comprising”, “including” and “having” are intended to be inclusive and mean that there may be additional elements other than the listed elements. The phrase “one or more of the following: A, B, and C” means “at least one of A and/or at least one of B and/or at least one of C.”

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A vehicle comprising:
a frame having a left side and a right side;
a plurality of wheels coupled to the frame, the plurality of wheels including a plurality of left wheels at the left side of the frame and a plurality of right wheels at the right side of the frame; and
a vehicle stability system including an actuator device selectively actuated to balance the vehicle on either the plurality of left wheels or the plurality of right wheels while maintaining a space between the other of the plurality of left wheels or the plurality of right wheels and a ground surface.

2. The vehicle of claim 1, wherein the vehicle stability system includes a vehicle attitude sensor configured to determine an orientation of the vehicle, the actuator device selectively actuated based on the orientation of the vehicle.

3. The vehicle of claim 1, wherein the vehicle stability system includes a wheel load sensor configured to determine a force associated with either or both of the plurality of left wheels or the plurality of right wheels, the actuator device selectively actuated based on the force.

4. The vehicle of claim 1, wherein the vehicle stability system includes a proximity sensor configured to determine a presence of the ground surface in an area proximate to either or both of the plurality of left wheels or the plurality of right wheels, the actuator device selectively actuated based on the presence.

5. The vehicle of claim 1, further comprising a lateral control system operably connected to the plurality of wheels for use in steering the vehicle, the actuator device selectively actuated to steer the vehicle using the lateral control system.

6. The vehicle of claim 1, further comprising a propulsion system operably connected to the plurality of wheels for use in propelling the vehicle, the actuator device selectively actuated to propel the vehicle using the propulsion system.

7. The vehicle of claim 1, further comprising a braking system operably connected to the plurality of wheels for use in restricting a rotation of the plurality of wheels, the actuator device selectively actuated to restrict the rotation of the plurality of wheels using the braking system.

8. The vehicle of claim 1, further comprising a suspension system coupling the plurality of wheels to the frame, the actuator device selectively actuated to move either or both of the plurality of left wheels or the plurality of right wheels using the suspension system.

9. The vehicle of claim 1, further comprising:
a seat; and
a mount coupled to the seat, the actuator device selectively actuated to move the seat using the mount.

10. The vehicle of claim 1, further comprising:
one or more of an engine or a motor; and
a mount coupled to the one or more of the engine or the motor, the actuator device selectively actuated to move the one or more of the engine or the motor using the mount.

11. The vehicle of claim 1, further comprising:
one or more of a battery pack or a fuel cell stack; and
a mount coupled to the one or more of the battery pack or the fuel cell stack, the actuator device selectively actuated to move the one or more of the battery pack or the fuel cell stack using the mount.

12. The vehicle of claim 1, further comprising:
a fuel tank; and
a mount coupled to the fuel tank, the actuator device selectively actuated to move the fuel tank using the mount.

13. The vehicle of claim 1, further comprising a fuel tank including at least one wall defining a cavity, the actuator device selectively actuated to move the at least one wall.

14. A vehicle stability system for use with a vehicle including a plurality of components, the plurality of components including a plurality of left wheels and a plurality of right wheels, the vehicle stability system comprising:
a sensor device configured to determine a parameter associated with the vehicle; and
an actuator device communicatively coupled to the sensor device, the actuator device configured to selectively move at least one component of the plurality of components based on the parameter to balance the vehicle on either the plurality of left wheels or the plurality of right wheels while maintaining a space between the other of the plurality of left wheels or the plurality of right wheels and a ground surface.

15. The vehicle stability system of claim 14, wherein the actuator device is selectively actuated to operate the vehicle using one or more of a lateral control system, a propulsion system, or a braking system.

16. The vehicle stability system of claim 14, wherein the actuator device is selectively actuated to move either or both of the plurality of left wheels or the plurality of right wheels using a suspension system.

17. The vehicle stability system of claim 14, wherein the actuator device is selectively actuated to move one or more of a seat, an engine, a motor, a battery pack, a fuel cell stack, or a fuel tank using a mount.

18. The vehicle stability system of claim 14, wherein the actuator device is selectively actuated to move at least one wall of a fuel tank defining a cavity.

19. A method for stabilizing a vehicle, the method comprising:
determining that at least one wheel of the vehicle is spaced from a ground surface; and
selectively actuating an actuator device to balance the vehicle on at least one other wheel while maintaining a space between the at least one wheel and the ground surface.

20. The method of claim 19, wherein selectively actuating the actuator device comprises adjusting one or more of a wheelbase or a weight distribution of the vehicle.
